(19) United States
(12) Patent Application Publication
(10) Pub. No.: US 2002/0014542 A1
(43) Pub. Date: Feb. 7, 2002

(54) Control device for a water spray

(76) Inventor: Roger Harold Creasey, West Hallam (GB)

Correspondence Address: TREXLER, BUSHNELL, GIANGIORGI & BLACKSTONE, LTD., 105 W. ADAMS STREET, CHICAGO, IL, 60603, US

(21) Appl. No.: 09/871,121

(22) Filed: May 31, 2001

(30) Foreign Application Priority Data
Jun. 24, 2000 (GB) 0015397.3

(51) Int. Cl. B05B 3/00

(52) U.S. Cl. 239/263.3

(57) ABSTRACT

A device for controlling the flow of water spray nozzle, comprises a valve member (E) normally biassed to a seated, closed position; an actuator (D) carried by a rotatable actuator shaft (C) and operable on the valve member (E) to displace the latter, against its bias, to an unseated, open position; a wheel (I) adapted, in use, to make frictional contact with the conveying run (K) of a loaded conveyor belt and to be rotated about an axis co-axial with that of the actuator shaft (C) by linear movement of the loaded belt, and a coupling means to couple wheel rotation to the actuator (D), and comprising firstly a disc or annulus (A) of electrically conducting material also rotatable about an axis co-axial with that of the wheel (I) and secondly a plurality of magnets (G) also carried by the actuator shaft (C) rotatable co-axially with the wheel (I) and disc or annulus (A) and located with air-gap spacing from the disc or annulus, with means to restrict the rotation of the actuator shaft (C) through a prescribed angle only.

### FIELD OF THE INVENTION

This invention relates to a control device for a water spray, particularly for emitting controlled water spray for dust suppression purposes.

### BACKGROUND OF THE INVENTION

In underground mineral mining operations, it is necessary to transport the mined product on underground conveyor belts great distances from a remote location, such as a coal face, to a bunker etc from where it can be brought above ground.

During such transport the mineral is disturbed (eg during transfer from one belt to another) dust is created. This dust traditionally is suppressed by spraying water onto the mineral usually at (or just before) a transfer point.

To automate such water spray, a device has been known for many years which opens a water valve when the conveyor belt is running and loaded with mineral. Whilst such devices have found wide acceptance, a degree of maintenance is required to ensure optimum operation, whilst manufacturing costs are relatively high.

### OBJECT OF THE INVENTION

A basic object of the present invention is the provision of an improved design of control device for a water spray for use with a belt conveyor.

### SUMMARY OF THE INVENTION

According to the present invention, there is provided a device for controlling the supply of water to a spray nozzle, comprising:

(i) a valve member normally biassed to a seated, closed position;

(ii) an actuator carried by a rotatable actuator shaft and operable on the valve member to displace the latter, against its bias, to an unseated, open position;

(iii) a wheel adapted to make frictional contact with the conveying run of a loaded conveyor belt and to be rotated about an axis co-axial with that of the actuator shaft by linear movement of the loaded belt, and

(iv) a coupling means connecting wheel rotation to the actuator, and comprising firstly a disc or annulus of electrically conducting material also rotatable about an axis co-axial with that of the wheel and secondly a plurality of magnets also carried by the actuator shaft rotatable co-axially with the wheel and disc or annulus and located with air-gap spacing from the disc or annulus, with means to restrict the rotation of the actuator shaft through a prescribed angle only.

### ADVANTAGES OF THE INVENTION

The device in accordance with the invention uses of course the “Faradays disc” principle and is of simpler construction than prior art proposals, using fewer moving parts and hence needs less maintenance and consequently is cheaper to manufacture and maintain. The use of a magnetic clutch in accordance with the invention, in contrast to a mechanical clutch minimises frictional wear, as there are no parts in contact, whilst excess energy is dissipated as heat by the disc or annulus of electrically conducting material.

### PREFERRED OR OPTIONAL FEATURES OF THE INVENTION

The valve member is a poppet valve member.

The valve member is biassed to its seated position by a coil compression spring.

A valve seat for the valve member is carried by a body member, having a water inlet port to one side of the valve seat, and a water outlet port to the other side of the valve seat.

The actuator comprises a cam carried at an end of the actuator shaft distal from the copper disc.

The wheel is carried at one end of a transmission shaft, while the copper disc is carried at the other end of the transmission shaft.

Opposite ends of the transmission shaft are supported by ball races.

The disc or annulus of electrically conducting material is of copper.

The annulus of copper etc is mounted on a mild steel disc.

The magnets are carried peripherally by a carrier disc.

Ten magnets are provided at 36° spacing.

The magnets are inset into the face of the disc adjacent the copper etc disc or annulus.

The carrier disc is mounted on the end of the shaft distal from the actuator.

The copper etc disc or annulus, magnets and carrier disc are located in an enclosed housing.

### BRIEF DESCRIPTION OF THE DRAWINGS

In the accompanying drawings,

FIG. 1 is a part sectional side elevation of a device in accordance with the invention; and

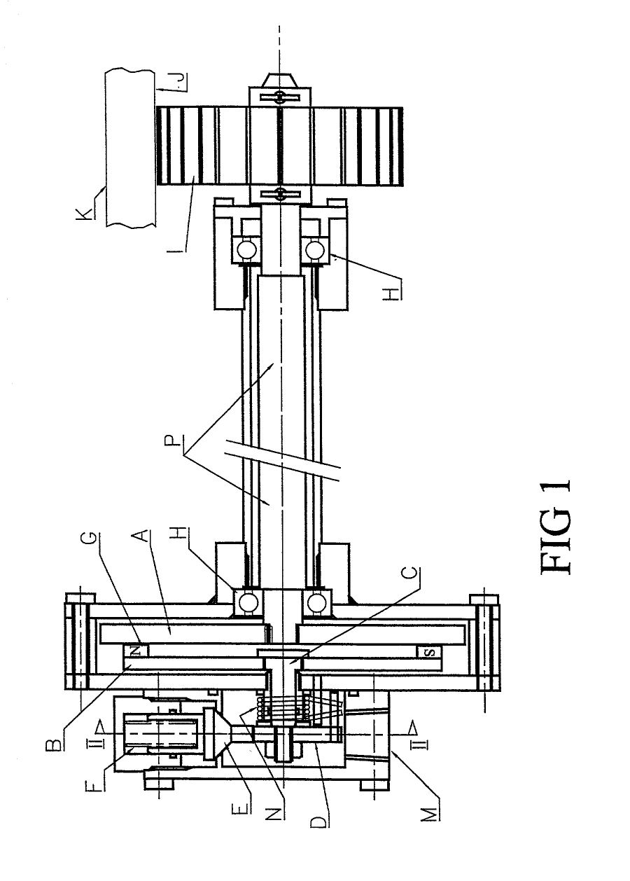

FIG. 2 is a view of the line II-II of FIG. 1.

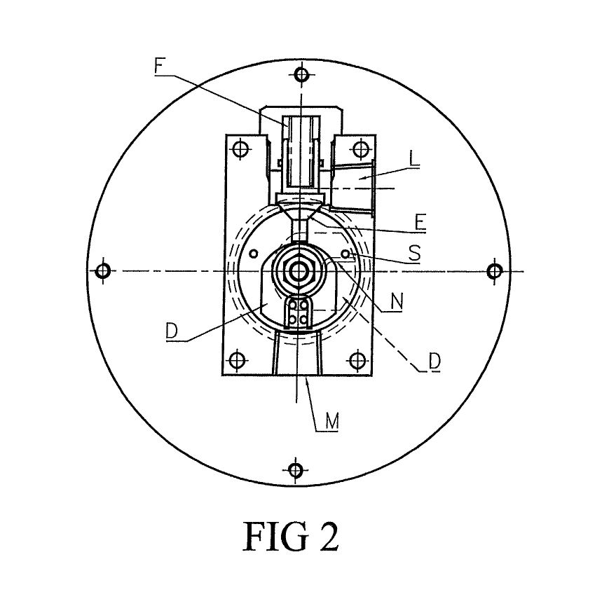

### DETAILED DESCRIPTION OF THE DRAWINGS

The drawings show, by way of example only, a device in accordance with the invention, in which, a rotatable copper disc (A) mounted on a mild steel disc (O) is located in close proximity to a similar sized carrier disc (B) for a plurality of permanent magnets (G) around its periphery. The movement of the copper disc (A) through the magnetic field produces eddy currents which produces a force to rotate the magnet carrier disc (B). The magnet disc has an actuator shaft (C) which carries an actuator in the form of a cam (D) which when rotated through a prescribed angle, unseats a simple poppet valve (E), the latter being displaced to an open position permitting water flow from a closed, seated position preventing water flow and to which it is biassed by a coil compression return spring (F).

The magnet carrier disc (B) only rotates approximately 90° up to a physical stop (S) but so long as the conveying run of the associated belt is running and loaded the copper disc (A) will continue to rotate ‘slipping’ past the magnet disc (B) after the latter is restrained.

This ensures that the valve (E) is displaced and hence unseated by the actuator whenever the copper disc (A) is rotated.

The copper disc (A) is rotated by a transmission shaft (P) carried in spaced-apart ball races (H), while the end of the transmission shaft (P) distal from the copper disc (A) carries a wheel (I) adapted, in use, to make frictional contact with the periphery (J) of the conveying run (K) of a conveyor belt, so as to rotate only when the belt is moving and is loaded.

When the copper disc (A) is not rotating the induced force diminishes to zero and the carrier disc (B) returns to its normal position due to a return spring (N).

A water inlet connection connected to a supply of pressurised water is indicated at (L) and a water outlet connection is indicated at (M), the outlet connection delivering water, when the valve (E) is unseated, to one or more spray nozzles (not shown) at a suitable location(s) in the vicinity of a transfer point.

What I claim is:

1. A device for controlling the flow of water to a spray nozzle, comprising:
(i) a valve member normally biassed to a seated, closed position preventing water flow;
(ii) an actuator shaft rotatable about an axis, carried by said shaft and operable on said valve member to displace the latter, against its bias, to an unseated, open position permitting water flow;
(iii) a wheel adapted, in use, to make frictional contact with a conveying run of a loaded conveyor belt and to be rotated about an axis co-axial with that of said actuator shaft by linear movement of said loaded belt, and
(iv) a coupling means to couple rotation of said actuator shaft by said wheel to said actuator, and comprising firstly at least a disc of electrically conducting material rotatable about an axis co-axial with that of said wheel, and secondly a plurality of magnets also carried by said actuator shaft and rotatable co-axially with said wheel and said annulus, and located with air-gap spacing from said annulus, with means to restrict rotation of said actuator shaft through a prescribed angle only.

2. A device as claimed in claim 1, wherein said valve member is a poppet valve member.

3. A device as claimed in claim 1, wherein said valve member is biassed to said seated, closed position by a coil compression spring.

4. A device as claimed in claim 1, wherein a valve seat for said valve member is carried by a body member, said body member having a water inlet port to one side of said valve seat, and a water outlet port to another side of said valve seat.

5. A device as claimed in claim 1, wherein said actuator comprises a cam carried at an end of said actuator shaft distal from said electrically conducting disc.

6. A device as claimed in claim 1, wherein said wheel is carried at one end of a transmission shaft, while said electrically conducting disc is carried at the other end of said transmission shaft.

7. A device as claimed in claim 6, wherein opposite ends of said transmission shaft are supported by ball races.

8. A device as claimed in claim 1, wherein said electrically conducting disc is of copper.

9. A device as claimed in claims 1, wherein said electrically conducting disc is mounted on a mild steel disc.

10. A device as claimed in claim 1, wherein said magnets are carried peripherally by a carrier disc.

11. A device as claimed in claim 1, wherein ten magnets are provided at 36° spacing.

12. A device as claimed in claim 10, wherein said magnets are inset into a face of said carrier disc adjacent said electrically conducting disc.

13. A device as claimed in claim 10, wherein said carrier disc is mounted on an end of said actuation shaft distal from said actuator.

14. A device as claimed in claim 10, wherein said annulus, said magnets and said carrier disc, are located in an enclosed housing.
